(19) United States
(12) Patent Application Publication
(10) Pub. No.: US 2015/0161518 A1
(43) Pub. Date: Jun. 11, 2015

(54) System and Method for Non-Invasive Application Recognition

(71) Applicant: Futurewei Technologies, Inc., Plano, TX (US)

(72) Inventor: Peter J. McCann, Bridgewater, NJ (US)

(21) Appl. No.: 14/561,012

(22) Filed: Dec. 4, 2014

Related U.S. Application Data
(60) Provisional application No. 61/912,349, filed on Dec. 5, 2013.

(51) Int. Cl. G06N 7/00; G06N 99/00

(52) U.S. Cl. CPC G06N 7/005; G06N 99/005

(57) ABSTRACT

A system and method are disclosed for a non-invasive scheme for application recognition using packet processing. The system and method determine the type of application based on meta-information about the packet flows, rather than on the contents of the packets. An embodiment method includes monitoring and storing, by a processor, direction values, timing values and size values of a sequence of packets for each of a plurality of application protocol types. The direction values are discrete, and the timing and size values are continuous. The method further includes training a hidden Markov model (HMM) for each of the application protocol types using a HMM training algorithm on the direction, timing and size values.

This application claims the benefit of U.S. Provisional Application No. 61/912,349 filed on Dec. 5, 2013 by Peter J. McCann and entitled “System and Method for Non-Invasive Application Recognition,” which is hereby incorporated herein by reference as if reproduced in its entirety.

### TECHNICAL FIELD

The present invention relates to networking and packet processing in telecommunications, and, in particular embodiments, to a system and method for non-invasive application recognition.

### BACKGROUND

Current approaches for recognizing application type and estimating Key Quality Indicators (KQIs) from packet traces makes use of Deep Packet Inspection (DPI) and a substantial library of application and protocol knowledge to determine the application type of each TCP flow. KQI metrics about the application instance can also be calculated, such as delay, success rate, and download bitrate. However, DPI can be expensive and impractical due to cost and security concerns. The processing of the contents of every packet can also require substantial computational resources. Further, users and operators may be uncomfortable sharing the contents of communication to equipment manufacturers and/or operators when it is not absolutely necessary for the operation of the network. Thus, there is a need for an enhanced scheme for application recognition, which can be less invasive (in terms of packet content probing), less expensive (e.g., resource demanding) and more secure.

### SUMMARY OF THE INVENTION

In accordance with an embodiment, a method for non-invasive application recognition includes obtaining, by a processor, a plurality of parameters observed for a sequence of packets for each of a plurality of application protocol types. The parameters include a discrete value parameter and continuous value parameters. A plurality of hidden Markov models (HMMs) corresponding to the application protocol types are then trained using training data including the parameters observed for the sequence of packets. The method further includes obtaining a plurality of values for the parameters observed for a new sequence of packets for an unknown application protocol type. The values are applied to each of the trained HMMs for computing an estimated likelihood that the unknown application protocol type is a respective application protocol type associated with each one of the trained HMMs. The unknown application protocol type is then classified as one of the application protocol types corresponding to one of the trained HMMs for which a maximum estimated likelihood is computed.

In accordance with another embodiment, a method for non-invasive application recognition includes monitoring and storing, by a processor, direction values, timing values and size values of a sequence of packets for each of a plurality of application protocol types. The direction values are discrete, and the timing and size values are continuous. The method further includes training a HMM for each of the application protocol types using a HMM training algorithm on the direction, timing and size values.

In accordance with yet another embodiment, an apparatus for non-invasive application recognition comprises at least one processor and a non-transitory computer readable storage medium storing programming for execution by the at least one processor. The programming includes instructions to obtain a plurality of parameters observed for a sequence of packets for each of a plurality of application protocol types. The parameters include a discrete value parameter and continuous value parameters. The programming includes further instructions to train a plurality of HMMs corresponding to the application protocol types using training data including the parameters, obtain a plurality of values for the parameters observed for a new sequence of packets for an unknown application protocol type, and apply the values to each of the trained HMMs. The programming instructions further compute an estimated likelihood that the unknown application protocol type is a respective application protocol type associated with each one of the trained HMMs. The unknown application protocol type is classified as one of the application protocol types corresponding to one of the trained HMMs for which a maximum estimated likelihood is computed.

The foregoing has outlined rather broadly the features of an embodiment of the present invention in order that the detailed description of the invention that follows may be better understood. Additional features and advantages of embodiments of the invention will be described hereinafter, which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 illustrates a sequence of packets corresponding to a TCP connection;

FIG. 2 illustrates a high level view of the training process for a Hidden Markov model (HMM);

FIG. 3 illustrates a classification process for previously-unseen examples;

FIG. 4 illustrates a confusion matrix for a fixed vector quantization model;

FIG. 5 illustrates a confusion matrix for a semi-continuous model;

FIG. 6 illustrates Density-Based Spatial Clustering of Applications with Noise (DBSCAN);

FIG. 7 illustrates a DBSCAN application to packet flows;

FIG. 8 illustrates a DBSCAN application to web pages;

FIG. 9 illustrates a clustering of data packets;

FIG. 10 illustrates another clustering of data packets;

FIG. 11 illustrates a cumulative distribution function;

FIG. 12 illustrates another cumulative distribution function;

FIG. 13 illustrates an embodiment of a non-invasive application recognition method; and

FIG. 14 is a diagram of a processing system that can be used to implement various embodiments.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

Disclosed herein are embodiments of a system and method for providing a non-invasive scheme for application recognition using packet processing. The embodiments include determining the type of application and hence the KQI metrics based on meta-information about the packet flows, rather than on the contents of the packets. The metrics obtained can then be used to evaluate the performance of a communications network, e.g., a wireless network, and provide input to operations and future capacity planning decisions. In an embodiment, Internet traffic is classified according to the application that produced it (e.g., web based application, voice, video, game, streaming or on demand content, machine to machine communications, or other), where both discrete and continuous observations of application traffic/packet patterns were available. For example, the direction of a packet (uplink or downlink) was encoded as one discrete bit, and the packet size and time interval between packets were encoded as continuous variables. Embodiment training and evaluation algorithms are thus used to handle the combination of discrete and continuous outputs in an efficient manner.

Hidden Markov models (HMMs), which are described in more detail below, have been applied in various applications, including speech recognition and traffic classification. One such model is the semi-continuous hidden Markov model that was introduced to handle the problem of continuous distributions or multivariate outputs depicting observation of application/traffic patterns. Such distributions or outputs are characterized by a mean and a covariance of a probability distribution function (pdf). By integrating the continuous distribution parameters into the model, each discrete output of the basic HMM is mapped to a single mean and covariance matrix, which is used to evaluate the probability of the hidden Markov state machine producing a given observed continuous output. This evaluation is important for both training the model parameters, for example using the Baum-Welch algorithm, and for evaluating a given time series to determine its likelihood of being produced by an already-trained model.

The system and method embodiments herein handle both discrete and continuous outputs in a HMM. The embodiments are described below in the context of Internet traffic classification, but may be applied to various other classification schemes, such as speech classification, arbitrary time-sequence classification, or others. Specifically, given a multivariate output with D discrete bits and a number of continuous components, where the standard semi-continuous model would have K outputs, an HMM is created with 2^{D}×K outputs to model the conditional probability of seeing each output distribution k (mean and covariance) given the discrete component of the observation. When evaluating the probability of a given observation, only those evaluations of the Gaussian parameters corresponding to the value of the discrete output in that observation are combined together. New equations for updating the output probability distribution matrix B are derived given a time series of observed outputs.

An embodiment allows for an independent set of Gaussian parameters (means and covariances) for each possible value of the discrete component of an output. Each set of Gaussians can evolve in a way that captures their conditionality upon the discrete variables. This leads to a more refined model and better accuracy when the model is used for classification. The embodiment HMM is applicable to recognizing the application that produced an observed stream of Internet packets. This is valuable to network operators so they can determine which applications their users are using on their network and then evaluate KQIs for each application type.

In one scenario, evaluating the performance of a wireless network includes two steps: determining which applications are being used on that network, and evaluating the application-specific KQI metrics for particular applications of interest. In this scenario, it is assumed that the availability of packet header information and packet timestamps observed at one particular point in the wireless network (the Iuₚₛ interface in this scenario). The results are compared with an existing Service Quality Assessment (SQA) version 4.3 tool run over the same data. The results outperformed the DPI scheme in terms of recognizing the application and protocol type of each packet and the calculated KQIs of application sessions that contained sequences of packets from multiple connections.

A sequence of time-stamped packet headers is used as input to the embodiment HMM. The sequence includes the Internet protocol (IP) and transfer control protocol (TCP) headers and overall length of each packet, leaving out the contents. A one-way hash function is used to erase any identifiable information from the packet headers such as user equipment (UE) or server IP addresses. This enabled the grouping of the packets into independent TCP connections and labeling each TCP connection with a unique identifier for the originating UE. This scheme also provides time series data for each flow and the mapping of flows to UEs, without identifying any particular UE, server, or TCP port number.

In an embodiment, techniques from machine learning are used to carry out the steps of recognizing the application type and of grouping the packets of one application into overall application instances (e.g., the download of a plurality of resources on one web page). After this grouping is performed, the available KQIs are calculated with suitable arithmetic over the packet sizes and timestamps. In an embodiment, the output of the SQA tool is used as a target to train the machine learning algorithms and to evaluate the correctness/accuracy of the results.

Determining application type from a time series of packet observations is a classification problem. Each time series (e.g., TCP connection) is labeled with an application type by the SQA tool, and the goal is to reproduce this classification without using any packet content information. The HMM has been shown to be successful in the machine learning community addressing this type of problem.

With respect to a discrete HMM approach, a standard training algorithm for an HMM was described by L. R. Rabiner, L.R. in a publication of the Proceedings of the IEEE, 1989, entitled “A tutorial on hidden Markov models and selected applications in speech recognition”. In its basic form, an HMM is a finite state machine coupled with an output distribution. The finite state machine is described by a matrix A, such that the matrix element Aᵢⱼ is the probability of transition from state i to state j. Each row of A must add up to 1. The output distribution is described by a matrix B, such that Bᵢₖ is the probability of observing output k when in state i. Each row of B must add up to 1. In the basic model, the output consists of a discrete set of symbols (yielding a finite number of columns in B). Operationally, the HMM models an underlying hidden process that iteratively emits an output according to a probability distribution determined by its current state, and then transitions to a next state according to its transition probability matrix. In the embodiments herein, we assume that the operation of a given application protocol is assumed suitable to be modeled in this way, taking the space of hidden states to be the cross-product of the possible states of both protocol endpoints, and the observed outputs to be the individual packets passing by an observation point. Once the HMM has been trained on particular examples of an application, it can be used to estimate the likelihood (e.g., a probability between 0 and 1) that a new, previously unseen example was generated by the same underlying process.

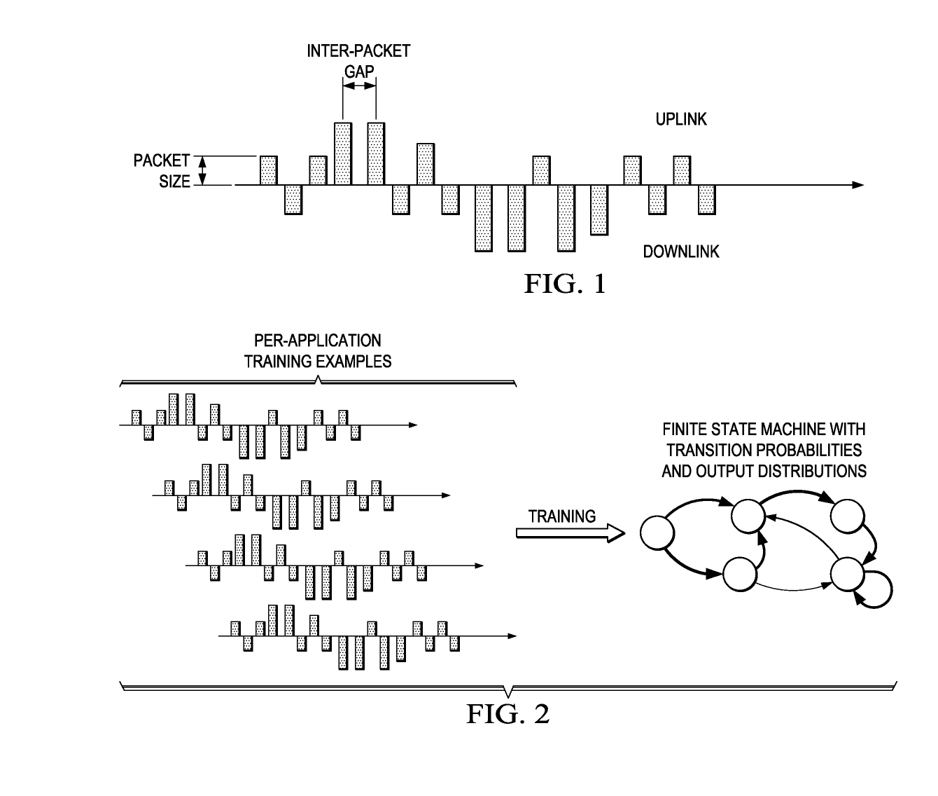

An abstract view of a TCP connection is shown in FIG. 1. To present each TCP connection to an HMM model for both training and testing, a sequence of observations (or traffic or packets) is encoded. It is assumed that there is information to exploit in both the timing and size of the sequence of packets or protocol exchange. Considering a discrete HMM, the intervals and packet sizes need to be quantized into a codebook. After experimenting with different codebook sizes, a length of 6 bits for the quantization vector is adopted. Initially, all the training data is aggregated, and implemented an LBG clustering algorithm is implemented, with a squared error distance metric to determine a good codebook. A LBG clustering algorithm is described by Y. Linde, et al. in a publication of IEEE Transactions on Communications 28: 84, 1980, entitled “An Algorithm for Vector Quantizer Design”. A scaled logarithm of the packet sizes and time intervals is clustered to this end. Each packet is then encoded into a 7-bit observation vector consisting of a direction bit and the 6-bit quantization of the two dimensional (packet size, time interval) data.

A standard discrete HMM training algorithm is used to train one HMM for each protocol type, using the labeled examples of that protocol type as decided by the SQA tool as input to the training process. FIG. 2 depicts a high level view of the training process for one HMM. The algorithm given by Rabiner is used to iteratively derive the proper values for the A and B matrices for each protocol type for which a minimum number of examples was used in both a training set and a testing set. This yielded a set of 26 HMMs, one for each of the application protocols in the data set for which at least 15 examples in both the training and testing sets are used.

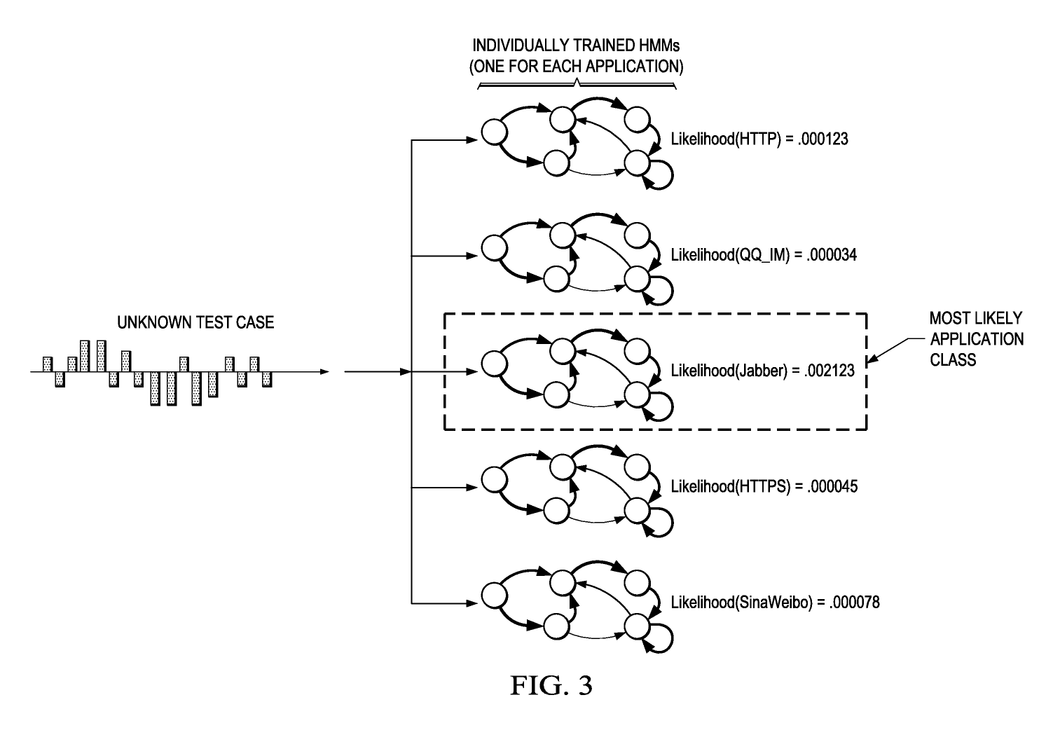

The whole set of 26 HMMs, once trained, can be used as a classification engine for future, previously unseen examples. The mechanism used for classifying a new example is to present it to each of the trained HMMs and compute the estimated likelihood that the test example is generated by each HMM. Hence, the output of the classification engine is the maximum likelihood over the trained HMMs. FIG. 3 illustrates a classification process for new, previously unseen examples.

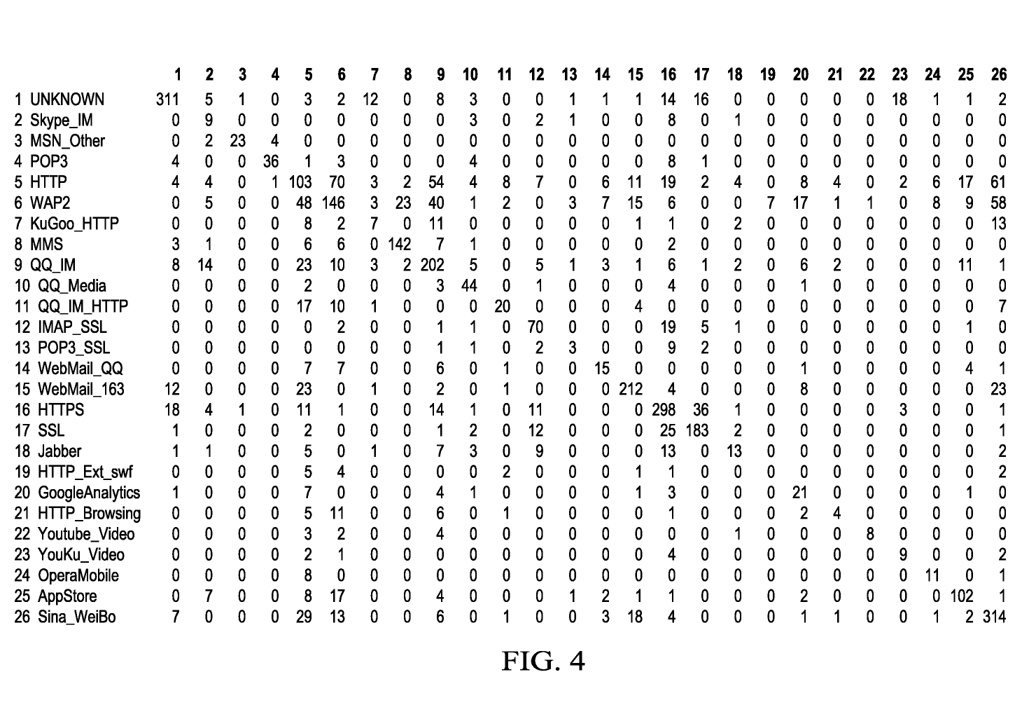

A classifier is constructed as outlined above for 26 application classes and a set of 3781 test cases is run through the classifier. The resulting confusion matrix for the set of 26 trained discrete HMMs using a fixed vector quantization model is shown in FIG. 4. In the confusion matrix, each row represents the classification results for test cases belonging to one application class. All of the cases in each row should have been classified as the application class labeled on the left hand side of the row. Thus, a 100% accuracy rate would have had zeros in every position except along the top-left to lower-right diagonal. If a non-zero number appears in some other column, this means that number of test cases was misclassified into the class given by the column number. Summing up the total of the diagonal and dividing by the total number of test cases, an accuracy rate of 61% is achieved. In this example, Hypertext Transfer Protocol (HTTP) and Wireless Application Protocol 2 (WAP2) protocol packets are confused with one another in 70 and 48 (a total of 118) cases. These protocols are very similar and are used in similar ways. Upon combining these two classes into one class and thus re-computing the confusion matrix, the accuracy rate increases to 64%.

After running multiple experiments in the discrete setting, there seemed to be some sensitivity in the accuracy rate to the quantization of the continuous variables, including the scale factors applied to the logarithms. Therefore, the semi-continuous hidden HMM is applied next (instead of the discrete HMM above). A semi-continuous hidden HMM is described by X. D. Huang et al. in a publication of the 1989 International Conference on Acoustics, Speech, and Signal Processing, ICASSP-89, May, 1989, entitled “Unified techniques for vector quantization and hidden Markov modeling using semi-continuous models”. In a semi-continuous HMM, the states and state transitions are still discrete, but the output probability distributions are treated as a discrete choice among multivariate single Gaussian distributions. In addition to the B matrix, which defines the probability of the discrete choice, there is a mean vector μₖ and a covariance matrix Σₖ for each discrete choice. In this example, each observation contains two continuous variables (packet size and time interval), so the mean vectors are two elements each and the covariance matrices are 2×2 matrices. Unlike in the standard model, all of the HMMs (one for every protocol class) share the same means and covariance matrices, and so the optimization of these parameters is a minimization of the error across all the models. As such, in terms of training the model parameters, the models for the different classes are trained at the same time, taking one Baum-Welch step in each model and then using the results from all models to re-compute the means and covariances to be used in the next round of training. This substantially increased the memory requirements of our training program compared to training one model at a time in isolation.

The standard training and likelihood evaluation algorithms from Rabiner requires evaluating the probability Pr[x|sᵢ] that a particular output x is produced by a particular state i of the underlying model. In the discrete case, this becomes Bᵢₖ for discrete output k from state i. However, in the semi-continuous case, this probability becomes:

Pr[x|sᵢ]=Σₖ₌₁^{k}BᵢₖN(x,μₖ,Σₖ).

In this example, a contribution is assumed from each possible discrete choice of separate Gaussian parameters, each evaluated at the output x. This fact is used to compute values for the forward and backward variables αₜ(i) and βₜ(i), which are defined as:

αₜ(i)=Pr[x₁, . . . xₜ, sₜ=i] and

βₜ(i)=Pr[xₜ₊₁, . . . x_{T}|sₜ=i].

Huang presented an equation for computing an intermediate result x which is the probability of making a transition at time t from i to j and choosing the discrete output k:

$$\begin{matrix}{χ}_{t} ( i , j , k ) = Pr [ {s}_{t} = i , {s}_{t + 1} = j , {O}_{k} \vert X , λ ] \\ = \frac{{α}_{t} ( i ) {A}_{ij} {B}_{i k} 𝒩 ( {x}_{t + 1} , {μ}_{k} , {\sum }_{k} ) {β}_{t + 1} ( j )}{Pr [ X \vert λ ]}\end{matrix}$$

which could then be used to compute the variables γ, the probability of transitions from i to j, and ζ, and the probability of choosing discrete output k when in state i:

γₜ(i,j)=Pr[sₜ=i,sₜ₊₁=j|X,λ],

γₜ(i)=Pr[sₜi|X,λ],

ζₜ(i,k)=Pr[sₜ=i, Oₖ|X,λ],

ζₜ(k)=Pr[Oₖ|,Xλ].

Huang proposed to compute these last four values by summing up χ over appropriate ranges. However, χ is only defined up to t=T−1, whereas values of γₜ(i) and ζₜ(i, k) when t=T are needed to update Bᵢₖ during the Baum-Welch iterative training procedure. Therefore, new equations are derived for γ and ζ based on our understanding of Rabiner's model and previous implementation of Baum-Welch. Taken together with proper implementation of scale factors, the following equation for γ can be formulated:

$${γ}_{t} ( i ) = \frac{{α}_{t} ( i ) {β}_{t} ( i )}{{c}_{t}}$$

where cₜ is the scale factor used at time t. To compute ζ, the following equation is formulated:

$${ζ}_{t} ( i , k ) = \frac{{γ}_{t} ( i ) {B}_{i k} 𝒩 ( {x}_{t} , {μ}_{k} , {\sum }_{k} )}{{\sum }_{l = 1}^{K} {B}_{il} 𝒩 ( {x}_{t} , {μ}_{l} , {{\sum }^{}}_{l} )} .$$

As such, the formulas from Huang, for instance, can be applied to update the A, B, μ, and Σ parameters.

In addition to using the continuous variables, one discrete bit is also used for the direction of the packet (uplink or downlink). Thus, a combination of discrete and continuous outputs is used in the model. This possibility is not considered in the existing literature. Therefore, new equations are derived herein for training and likelihood evaluation of these hybrid-output HMMs.

In the hybrid case, a number of discrete bits in addition to the continuous outputs are used. Thus, the output x can be divided into two parts (x^{d},x^{c}). In each state, the model makes an output choice consisting of d discrete bits and c bits that determine which Gaussian parameters are used to evaluate the continuous vector x^{c}. These choices may not be independent. Therefore, K=2^{d+c} columns are needed in the B matrix. The probability of a particular output in a particular state can then be computed as:

Pr[x^{d},x^{c}|sᵢ]=Σ₂_{^{c}}ₓ_{^{d}}_{<k≦2}_{^{c}}₍ₓ_{^{d}}₊₁₎BᵢₖN(x^{c},μₖ,Σₖ)

with zero contribution from the columns of B that do not correspond to the choice of discrete bits. This approach is propagated through the equations used for training and evaluation.

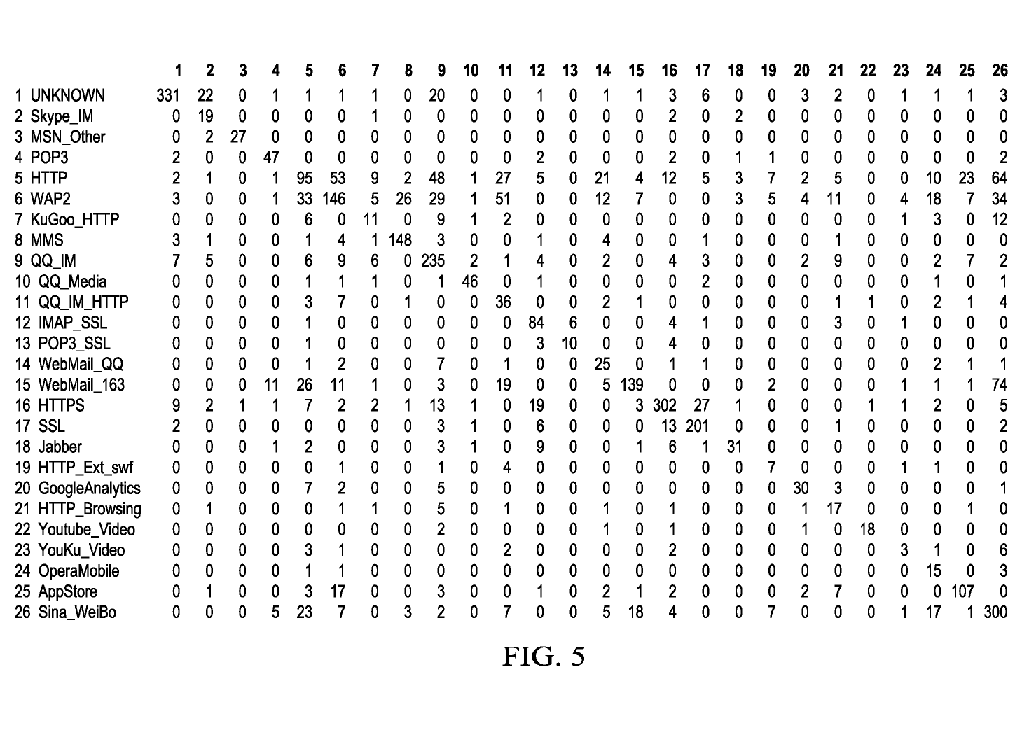

FIG. 5 illustrates a confusion matrix for the semi-continuous model, with an accuracy rate of 64%. In the case where HTTP and WAP2 are considered one class, the accuracy rate improves to 67%. The move to the semi-continuous model does not substantially improve the results.

Once an application has been correctly recognized, the estimation of the KQI metrics can be performed. This involves taking all the packets that were involved in the invocation of a single application instance (such as the download of a web page) and computing metrics such as the delay and bitrate. A typical web page can consist of several resources (images and chunks of text or formatting files), and multiple TCP connections are typically used to download the complete set of resources. A mechanism called persistent HTTP also allows the same TCP connection to be re-used for different resources across multiple web pages. The first task, then, is to determine which packets of a TCP connection correspond to the individual web pages. Next, the KQI of the application can be estimated by computing sums over the packets of a web page and calculating time intervals between the first and last packets of a web page.

In the non-invasive setting, there is no access to the contents of the packets and thus machine learning approximations can be used to determine the grouping of packets to web pages. In an embodiment, a clustering algorithm called Density-Based Spatial Clustering of Applications with Noise (DBSCAN) is used. A DBSCAN is described by M. Ester, et al. in a publication of the Proceedings of the Second International Conference on Knowledge Discovery and Data Mining (KDD-96), AAAI Press, pp. 226-231, 1996, entitled “A density-based algorithm for discovering clusters in large spatial databases with noise”. Starting with each point as a potential seed, the algorithm iteratively computes clusters by calculating the density of a neighborhood around an existing cluster of points and recursively adding those points if the density criteria are met.

The DBSCAN is applied in two layers. First, it is applied to each connection to produce a set of clusters that are expected to correspond to individual HTTP GET or POST requests and the associated responses. Next, a second level of clustering is applied to the requests across all the connections of the same application type belonging to the same UE. This clustered the requests into approximations of the web pages on which it is desired to perform KQI estimation.

For flow grouping, multiple TCP connections are used to download the resources on a web page. A single TCP connection can be re-used (HTTP persistent connections) to download resources for multiple web pages. In calculating KQI, packets are allocated to web pages. In a first step, packets are clustered within each flow to find the traffic corresponding to each downloaded resource. In a second step, the clusters found in the first steps are clustered to find all the packets involved in a single web page.

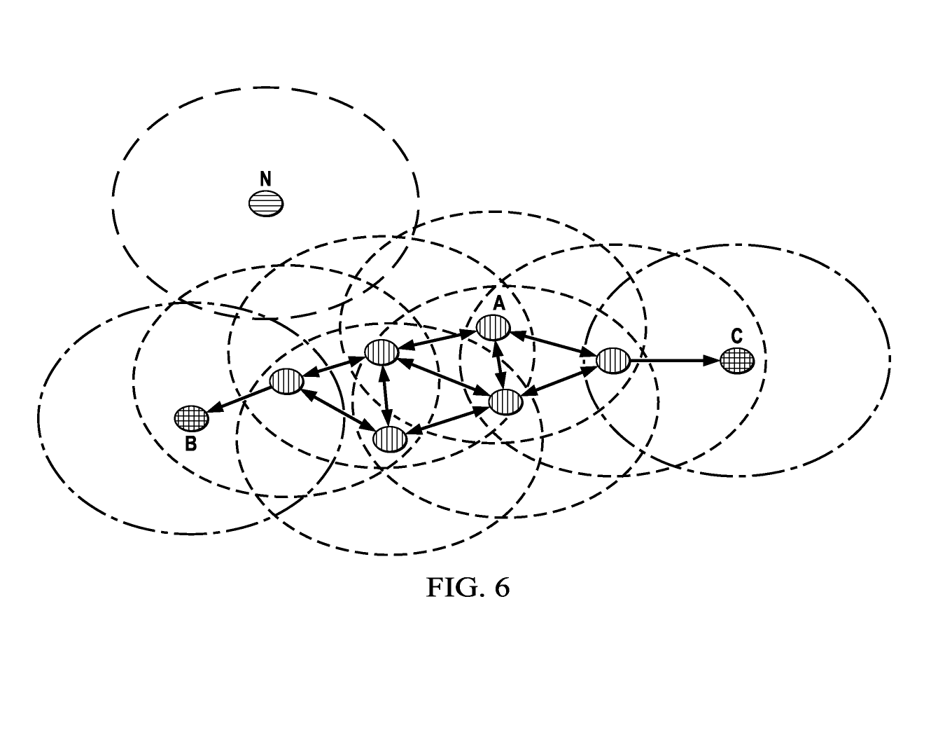

Density based spatial clustering of applications with noise (DBSCAN) is shown in FIG. 6. In the algorithm, there are two parameters, Epsilon (ε) and Minimum Cluster Size (minPts). It starts with an arbitrary point, and finds all neighbors within distance ε. If the neighborhood contains >=minPts, it starts a new cluster and recurses. If the neighborhood contains <minPts, it is noise, so it is ignored.

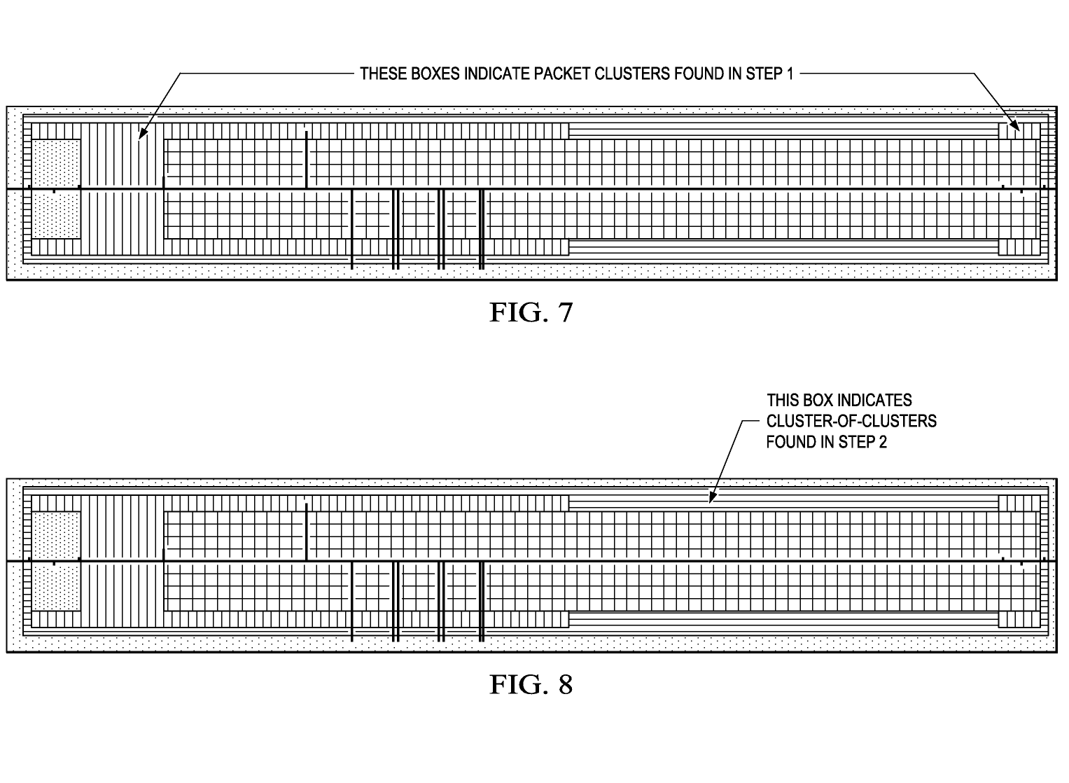

FIGS. 7 and 8 illustrate DBSCAN application to packet flows. In FIG. 7, a first step clusters packets within a single flow, using ε=0.7 seconds, and minPts=3. In FIG. 8, a second step clusters the clusters into web pages. A custom distance metric is defined between the intervals represented by each resource cluster (boxes pointed out in FIG. 7). DBSCAN is run with ε=3, and minPts=1.

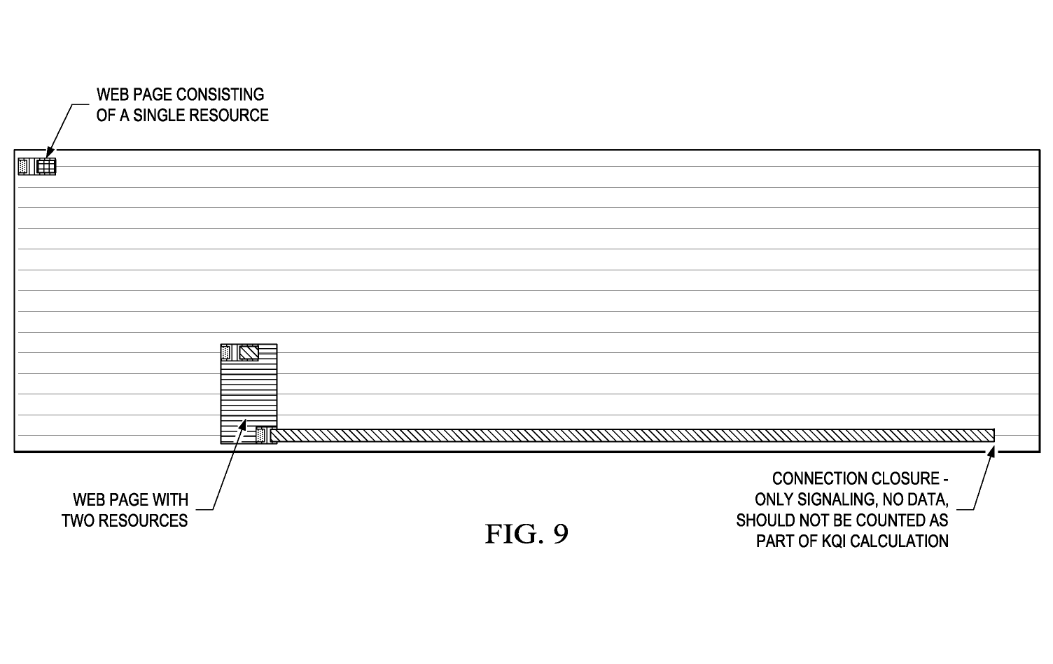

A WebGL-based tool is built to visualize the resulting clusters. An illustration from this tool is shown in FIG. 9. FIG. 9 illustrates a clustering of data packets, where each horizontal line represents a TCP connection. The smaller boxes are the first level clusters within individual connections, and the larger box is the second-level cluster that spans multiple connections.

Each horizontal line in FIG. 9 represents the timeline of a single TCP connection that was classified by the SQA tool as HTTP traffic. The upper small box and the two smaller boxes within the larger box indicate the result of first-level clustering, and they group packets together on a single connection. The larger box represents the second level of clustering, and it represents a group of requests and responses corresponding to a single web page download. The light-shaded areas represent the actual web page IDs found by the SQA tool. In this case DBSCAN found the two web pages and grouped them together correctly. The long horizontal light-shaded line extends out beyond the end of the cluster that was found, because the SQA tool may not give an accurate indication of where the web page ends and tends to include the connection-close event that takes place after the connection has been idle for some time. This interval and the signaling packets closing the connection may not be counted as part of the flow for purposes of calculating KQI.

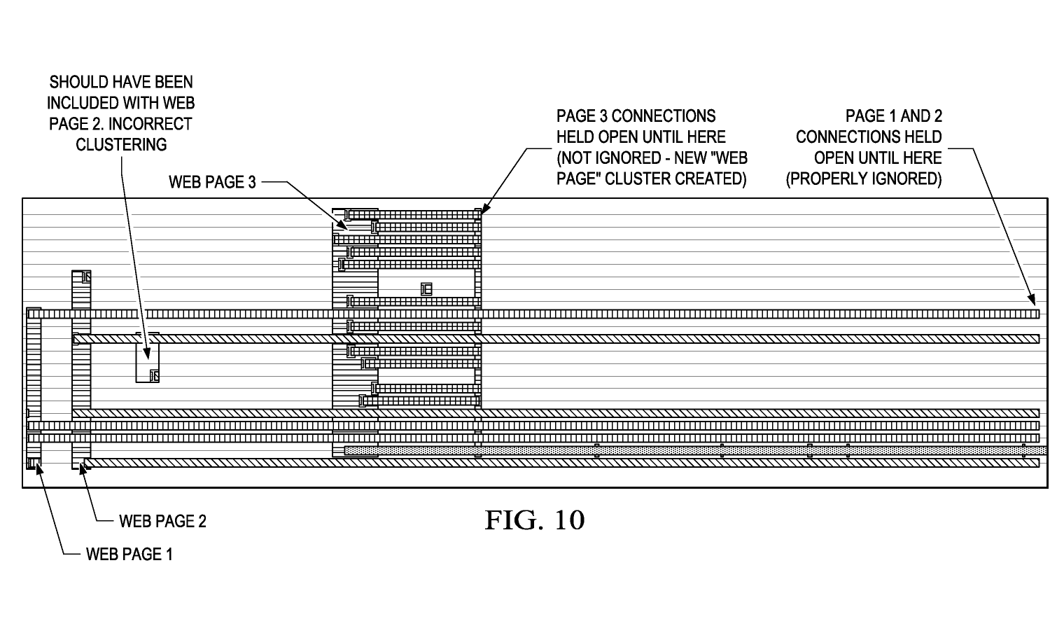

A second illustration is given in FIG. 10. In this case, the DBSCAN algorithm found 6 clusters. The clusters correspond roughly to those web pages identified by the SQA tool. Web page 2 was separated into two separate clusters. Further, a second cluster was created for the signaling that closes all the web page 3 connections.

The overall results were compared to the SQA tool, which produced a database table called HTTPKQI with individual records for each web page found. In all, DBSCAN identified 19403 clusters, in contrast to the SQA tool which produced 14195 entries in the HTTPKQI table for the same period of time. A total of 10863 of the DBSCAN clusters had the same starting packet as one of the entries in the HTTPKQI table. This indicates that the correct starting packet of a cluster is found about 76% of the time.

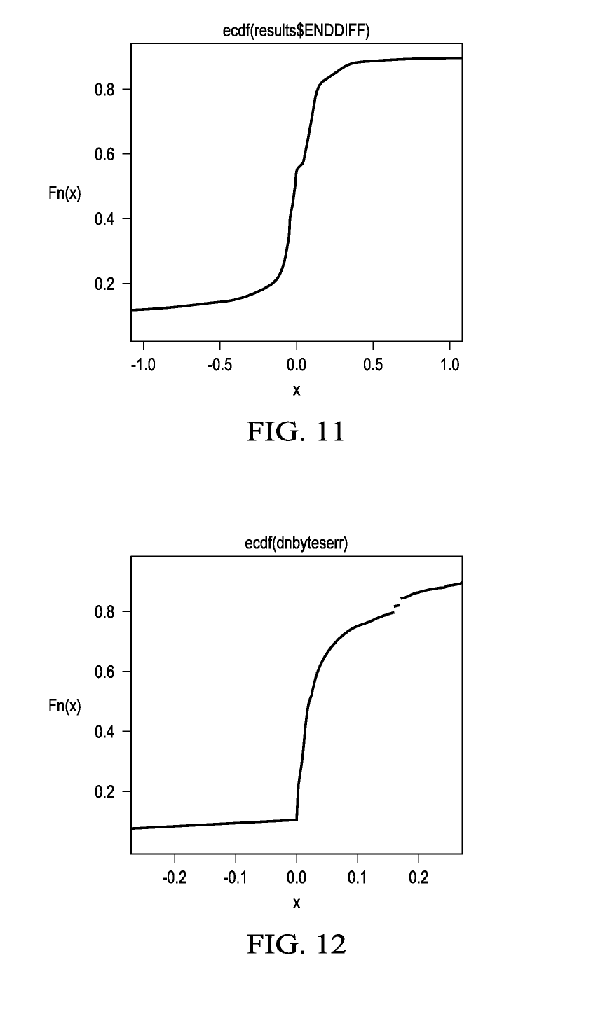

Of the clusters with a correct starting packet, the end times are within 100 millisecond (ms) of the end time in the HTTPKQI table at about 50% of the time. FIG. 11 illustrates a cumulative distribution function (CDF) of the ending time differences in the web page ending time of the DBSCAN clusters versus the HTTPKQI table for those web pages for which the starting packet was recognized correctly.

The implied number of bytes downloaded for each cluster whose starting packet was correctly identified (the 10863 clusters) is within 10% of the SQA database listed value at about 65% of the time. FIG. 12 illustrates a cumulative distribution function of the difference in implied downloaded bytes as a fraction of the total bytes recorded by the SQA tool for those web pages for which the starting packet was recognized correctly.

In above embodiment machine learning algorithms for application classification and KQI estimation provide approximations to the data produced by the deep packet inspection SQA utility. The algorithm results show that it is possible in various cases to recognize the correct application. In various cases, it is possible to correctly group the packets of an application into web pages. The groupings can produce packet counts and web page download time durations that are close to the values found by the SQA tool.

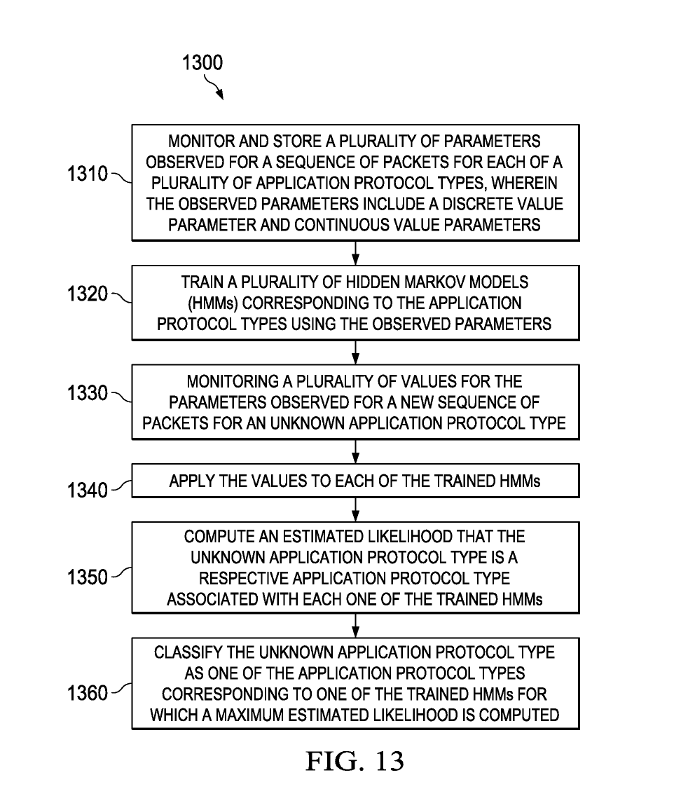

FIG. 13 shows an embodiment method for non-invasive application recognition. At step 1310, monitoring and storing, by a processor, a plurality of parameters are observed for a sequence of packets for each of a plurality of application protocol types. The observed parameters include a discrete value parameter, such as direction of packets, and continuous value parameters, such as the packet size and time interval between packets. The observed parameters are stored. At step 1320, a plurality of hidden Markov models (HMMs) corresponding to the application protocol types are trained using the observed parameters and a HMM training algorithm. At step 1330, a plurality of values for the parameters are monitored for a new sequence of packets of an unknown application protocol type. At step 1340, the values are applied to each of the trained HMMs. At step 1350, an estimated likelihood that the unknown application protocol type is a respective application protocol type associated with each one of the trained HMMs is computed. At step 1360, the unknown application protocol type is classified as one of the application protocol types corresponding to one of the trained HMMs for which a maximum estimated likelihood is computed.

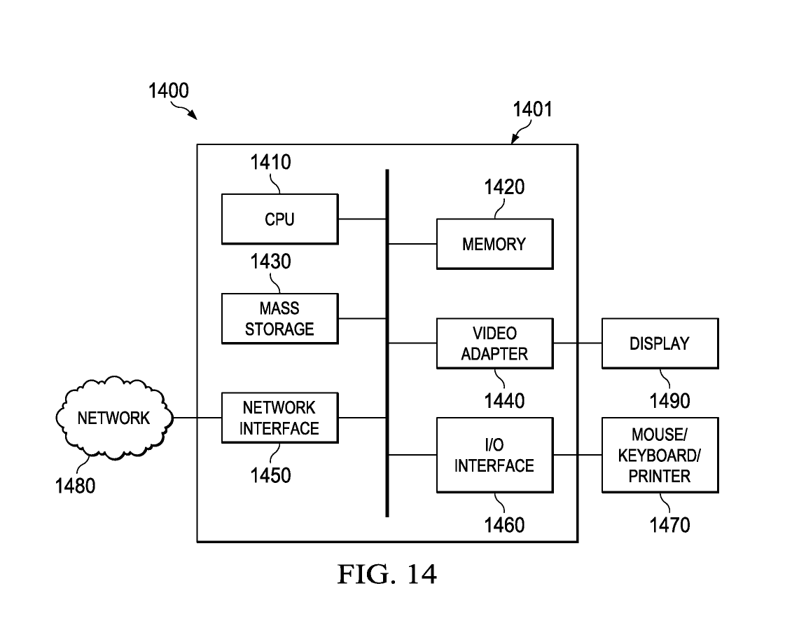

FIG. 14 is a block diagram of a processing system 1400 that can be used to implement various embodiments and algorithms above. For instance the processing system 1400 can be part of a UE, such as a smart phone, tablet computer, a laptop, or a desktop computer. The system can also be part of a network entity or component that serves the UE, such as a base station or a WiFi access point. The processing system can also be part of a network component, such as a base station. Specific devices may utilize all of the components shown, or only a subset of the components, and levels of integration may vary from device to device. Furthermore, a device may contain multiple instances of a component, such as multiple processing units, processors, memories, transmitters, receivers, etc. The processing system 1400 may comprise a processing unit 1401 equipped with one or more input/output devices, such as a speaker, microphone, mouse, touchscreen, keypad, keyboard, printer, display, and the like. The processing unit 1401 may include a central processing unit (CPU) 1410, a memory 1420, a mass storage device 1430, a video adapter 1440, and an I/O interface 1460 connected to a bus. The bus may be one or more of any type of several bus architectures including a memory bus or memory controller, a peripheral bus, a video bus, or the like.

The CPU 1410 may comprise any type of electronic data processor. The memory 1420 may comprise any type of system memory such as static random access memory (SRAM), dynamic random access memory (DRAM), synchronous DRAM (SDRAM), read-only memory (ROM), a combination thereof, or the like. In an embodiment, the memory 1420 may include ROM for use at boot-up, and DRAM for program and data storage for use while executing programs. In embodiments, the memory 1420 is non-transitory. The mass storage device 1430 may comprise any type of storage device configured to store data, programs, and other information and to make the data, programs, and other information accessible via the bus. The mass storage device 1430 may comprise, for example, one or more of a solid state drive, hard disk drive, a magnetic disk drive, an optical disk drive, or the like.

The video adapter 1440 and the I/O interface 1460 provide interfaces to couple external input and output devices to the processing unit. As illustrated, examples of input and output devices include a display 1490 coupled to the video adapter 1440 and any combination of mouse/keyboard/printer 1470 coupled to the I/O interface 1460. Other devices may be coupled to the processing unit 1401, and additional or fewer interface cards may be utilized. For example, a serial interface card (not shown) may be used to provide a serial interface for a printer.

The processing unit 1401 also includes one or more network interfaces 1450, which may comprise wired links, such as an Ethernet cable or the like, and/or wireless links to access nodes or one or more networks 1480. The network interface 1450 allows the processing unit 1401 to communicate with remote units via the networks 1480. For example, the network interface 1450 may provide wireless communication via one or more transmitters/transmit antennas and one or more receivers/receive antennas. In an embodiment, the processing unit 1401 is coupled to a local-area network or a wide-area network for data processing and communications with remote devices, such as other processing units, the Internet, remote storage facilities, or the like.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method for non-invasive application recognition comprising:
obtain, by a processor, a plurality of parameters observed for a sequence of packets for each of a plurality of application protocol types, wherein the parameters include a discrete value parameter and continuous value parameters;
training a plurality of hidden Markov models (HMMs) corresponding to the application protocol types using training data including the parameters observed for the sequence of packets;
obtain a plurality of values for the parameters observed for a new sequence of packets for an unknown application protocol type;
applying the values to each of the trained HMMs;
computing an estimated likelihood that the unknown application protocol type is a respective application protocol type associated with each one of the trained HMMs; and
classifying the unknown application protocol type as one of the application protocol types corresponding to one of the trained HMMs for which a maximum estimated likelihood is computed.

2. The method of claim 1, wherein the HMMs are trained using a HMM training algorithm on the training data comprising, for the sequence of packets for each of the application protocol types, one or more discrete bits for representing the discrete value parameter, and further comprising a vector of continuous variables for representing the continuous value parameters.

3. The method of claim 1, wherein the discrete value parameter indicates a direction of the packets, and wherein the continuous value parameters indicate a timing and a size of the packets.

4. The method of claim 1, wherein each one of the HMMs comprises a finite state machine including probabilities of transitioning between a plurality of states, and an output distribution including probabilities of observing a specific output in a specific state.

5. The method of claim 4, wherein, for each one of the states, the HMMs provide an output divided into a number of discrete bits (d) for representing the discrete value parameter, and a plurality of additional bits (c) that determine Gaussian parameters for representing the continuous value parameters, and wherein the HMMs comprise an output probability distribution matrix (B) comprising a number of columns equal to 2^{d+c}.

6. The method of claim 5, wherein the HMMs calculate a probability (Pr) of a particular output (x) in a particular state (i) as Pr[x^{d},x^{c}|sᵢ]=Σ₂_{^{c}}ₓ_{^{d}}<k≦2₍ₓ₊₁)BᵢₖN(x^{c},μₖ,Σₖ), where N is a multivariate normal distribution function, μₖ is a mean of N, and Σₖ is a variance of N.

7. The method of claim 1, wherein the continuous value parameters are Gaussian distribution parameters including a mean and a variance for determining a Gaussian distribution function for each one of the continuous value parameters.

8. The method of claim 1 further comprising evaluating a Key Quality Indicator (KQI) for the new sequence of packets in accordance with classifying the unknown application protocol type as one of the application protocol types, wherein evaluating the KQI for the packets includes determining at least one of delay and bitrate of the packets.

9. The method of claim 1, wherein the unknown application protocol type is classified without analyzing content of the new sequence of packets.

10. The method of claim 1, wherein the processor is located at a user equipment (UE) or a network end component.

11. A method for non-invasive application recognition comprising:
monitoring and storing, by a processor, direction values, timing values and size values of a sequence of packets for each of a plurality of application protocol types, wherein the direction values are discrete, and wherein the timing and size values are continuous; and
training a hidden Markov model (HMM) for each of the application protocol types using a HMM training algorithm on the direction, timing and size values.

12. The method of claim 11, wherein each HMM comprises a finite state machine including probabilities of transitioning between states, and an output distribution including probabilities of observing a specific output in a specific state.

13. The method of claim 11, further comprising, after the monitoring, storing and training:
monitoring, by the processor, new direction values, new timing values and new size values of a new sequence of packets for an unknown application protocol type;
applying the new direction values, timing values and size values to each of the trained HMMs;
computing an estimated likelihood that the unknown application protocol type is a respective application protocol type associated with each trained HMMs; and
classifying the unknown application protocol type as a specific application protocol type in accordance with a maximum one of the estimated likelihoods.

14. The method of claim 11, wherein the HMM training algorithm comprises a one discrete bit for representing the direction values, and further comprises a predefined number of additional bits the discrete value parameter and further comprising a predefined number of additional bits representing the continuous value parameters.

15. An apparatus for non-invasive application recognition comprising:
at least one processor;
a non-transitory computer readable storage medium storing programming for execution by the at least one processor, the programming including instructions to:
obtain a plurality of parameters observed for a sequence of packets for each of a plurality of application protocol types, wherein the parameters include a discrete value parameter and continuous value parameters;
train a plurality of hidden Markov models (HMMs) corresponding to the application protocol types using training data including the parameters;
obtain a plurality of values for the parameters observed for a new sequence of packets for an unknown application protocol type;
apply the values to each of the trained HMMs;
compute an estimated likelihood that the unknown application protocol type is a respective application protocol type associated with each one of the trained HMMs; and
classify the unknown application protocol type as one of the application protocol types corresponding to one of the trained HMMs for which a maximum estimated likelihood is computed.

16. The apparatus of claim 15, wherein the HMMs are trained using a HMM training algorithm on the training data comprising, for each sequence of packets for each of the application protocol types, one or more discrete bits for representing the discrete value parameter, and further comprising a vector of continuous variables for representing the continuous value parameters.

17. The apparatus of claim 15, wherein the discrete value parameter indicates a direction of the packets, and wherein the continuous value parameters indicate a timing and a size of the packets.

18. The apparatus of claim 15, wherein each one of the HMMs comprises a finite state machine including probabilities of transitioning between states, and an output distribution including probabilities of observing a specific output in a specific state.

19. The apparatus of claim 15, wherein the continuous value parameters are Gaussian distribution parameters including a mean and a variance for determining a multivariate Gaussian distribution function for the continuous value parameters.

20. The apparatus of claim 15, wherein the apparatus corresponds to a user equipment (UE) or a network end component.
